(19) United States
(12) Patent Application Publication
(10) Pub. No.: US 2011/0267152 A1
(43) Pub. Date: Nov. 3, 2011

(54) WIDEBAND TRANSMISSION LINE - WAVEGUIDE TRANSITION APPARATUS

(75) Inventor: Jung Aun LEE, Gyunggi-do (KR)

(73) Assignee: SAMSUNG ELECTRO-MECHANICS CO., LTD., Gyunggi-do (KR)

(21) Appl. No.: 12/862,735

(22) Filed: Sep. 21, 2010

(30) Foreign Application Priority Data
Apr. 30, 2010 (KR) 10-2010-0040863

(51) Int. Cl. H01P 5/103

(52) U.S. Cl. 333/26; 333/33

(57) ABSTRACT

Disclosed herein is a wideband transmission line—waveguide transition apparatus. The wideband transmission line—waveguide transition apparatus includes: a waveguide constituted by a single dielectric substrate; a transmission line applying a signal to the waveguide; and a cavity matching unit in which a cavity of which an inner surface is formed by a metallic surface is formed at a portion of the waveguide to contact with the transmission line and impedance is adjusted through a change of the dielectric constant in the cavity caused by changing the size and shape of the cavity to perform impedance matching between the waveguide and the transmission line, and the position of the cavity is changed to perform phase matching between the waveguide and the transmission line.

### CROSS REFERENCE TO RELATED APPLICATION

This application claims the benefit of Korean Patent Application No. 10-2010-0040863, filed on Apr. 30, 2010, entitled “Wideband Transmission Line—Waveguide Transition Apparatus”, which is hereby incorporated by reference in its entirety into this application.

### BACKGROUND OF THE INVENTION

1. Technical Field

The present invention relates to a wideband transmission line—waveguide transition apparatus.

2. Description of the Related Art

As a known transmission and receiving system, a product configuring a system by assembling separate parts is generally used. However, in recent years, a research of a system on package (SOP) product configuring a transmission and receiving system of a millimeter wave band by a single packet has been in progress and some products are being commercialized.

As a high-efficient wideband transmission line in the millimeter wave band, a waveguide line is considered.

The waveguide line has better transmission characteristics including a small transmission loss at a high frequency, a wideband characteristic, etc., than a microstrip line.

In general, the waveguide line made of metal has a smaller size in proportion to a wavelength as the frequency increases. Therefore, the waveguide line formed by mechanical processing using the metal is difficult to be manufactured and has high manufacturing cost due to its smaller size.

Further, in the device connection, it is difficult to directly connect the waveguide line and a universal subminiature A (SMA) or a transitioner using a via is generally used.

Herein, a transitioner between a coaxial line and the waveguide line is referred to as a coaxial-waveguide transitioner and a transitioner between the microstrip line and the waveguide line is referred to as a microstrip-waveguide transitioner. Currently, researches on the transitioners in the millimeter band (e.g., 20 to 300 GHz) are in progress.

In the case of the coaxial-waveguide transitioner, a concern with a low-loss transmission line is increasing in order to reduce the transmission loss, particularly, in connection between devices in the millimeter wave band.

When the waveguide line is used as the low-loss transmission line, the biggest problem is that a band is narrowed by an impedance difference and a conversion loss is increased at the time of propagation-transitioning from the microstrip line or the coaxial line to the waveguide line.

Moreover, when a dielectric substrate is used in the millimeter wave band, a conversion characteristic from the microstrip line or the coaxial line to the waveguide line is further deteriorated by progress rate and properties of a substrate.

In the case of a conversion structure of the known coaxial—waveguide transitioner, a wideband coaxial—waveguide transition apparatus is provided by inserting a probe serving as an electromagnetic wave dipole antenna into metal or a device improving a band characteristic through a structure using a dielectric coaxial line where an airline is formed around the probe is also proposed.

However, the known coaxial—waveguide transitioner can acquire a low-loss wideband characteristic, but characteristics of the transitioner are determined by a matching short position and a distance from the top plate of the waveguide to the top of the inner probe in respect to the structure.

Accordingly, when the smaller the waveguide is, the higher the frequency is, forming the probe and the airline in the waveguide by the mechanical processing becomes difficult and the manufacturing cost is increased.

Further, in recent years, the dielectric substrate has been generally used at high frequency. In this case, it is difficult to apply the known coaxial—waveguide transitioner structure to the dielectric substrate and a multi-layer substrate or a thin substrate.

Meanwhile, as another known coaxial—waveguide transitioner, a method of achieving wideband characteristics by installing a metal plate, a metal bar, and a metal post for connection with the device in a dielectric waveguide has been proposed.

However, even in such a method, while implementation using the dielectric substrate is possible, implementation using the metal waveguide is difficult, in the millimeter wave band.

Further, the metal bar inserted between the dielectric substrates needs thickness and length enough to implement the wideband characteristics, the thickness of the waveguide should be ensured to some extent in order to form the metal bar, and diameters of an inner conductor and the metal post of the coaxial line should also have sufficient sizes.

Therefore, when sufficient thickness of the waveguide cannot be ensured due to a manufacturing or design condition, it is difficult to apply the above-mentioned known method.

### SUMMARY OF THE INVENTION

The present has been made in an effort to provide a wideband transmission line—waveguide transition apparatus which can be implemented on a dielectric substrate in a millimeter wave band.

A wideband transmission line—waveguide transition apparatus according to a preferred embodiment of the present invention includes: a waveguide constituted by a single dielectric substrate; a transmission line applying a signal to the waveguide; and a cavity matching unit in which a cavity of which an inner surface is formed by a metallic surface is formed at a portion of the waveguide to contact with the transmission line and impedance is adjusted through a change of the dielectric constant in the cavity caused by changing the size and shape of the cavity to perform impedance matching between the waveguide and the transmission line, and the position of the cavity is changed to perform phase matching between the waveguide and the transmission line.

Further, the waveguide includes: a single dielectric substrate constituted by one dielectric layer; a first conductive plate formed on the top of the single dielectric substrate; a second conductive plate formed on the bottom of the single dielectric substrate; and a plurality of first metal via holes that have openings on one surface of side surfaces of the single dielectric substrate and are spaced to surround the side surfaces of the single dielectric substrate to form metal interfaces on the side surfaces of the single dielectric substrate.

In addition, the transmission line is a coaxial line including: a center conductor that is inserted into the waveguide to contact with the cavity matching unit and integrally formed with a probe conductor applying the signal to the waveguide; and an insulator surrounding the center conductor.

Moreover, the probe conductor is a second metal via hole.

Besides, in the cavity matching unit, an inner part of the cavity is filled with a metallic material.

Further, the cavity matching unit has a cylindrical shape or a polygonal shape.

A wideband transmission line—waveguide transition apparatus according to another embodiment of the present invention includes: a waveguide constituted by a plurality of dielectric layers; a transmission line applying a signal to the waveguide; and a cavity matching unit in which a cavity of which an inner surface is formed by a metallic surface is formed at a portion of one or more dielectric layers among the plurality of dielectric layers to contact with the transmission line and impedance is adjusted through a change of the dielectric constant in the cavity caused by changing the size and shape of the cavity to perform impedance matching between the waveguide and the transmission line, and the position of the cavity is changed to perform phase matching between the waveguide and the transmission line.

Further, the waveguide includes: a multi-layer dielectric substrate stacked by a plurality of dielectric layers; a first conductive plate formed on the top of the multi-layer dielectric substrate; a second conductive plate formed on the bottom of the multi-layer dielectric substrate; and a plurality of first metal via holes that have openings on one surface of side surfaces of the multi-layer dielectric substrate and are spaced to surround the side surfaces of the multi-layer dielectric substrate to form metal interfaces on the side surfaces of the multi-layer dielectric substrate.

In addition, the transmission line is a coaxial line including: a center conductor that is inserted into the waveguide to contact with the cavity matching unit and is formed integrally with a probe conductor applying the signal to the waveguide; and an insulator surrounding the center conductor.

Moreover, the transmission line is a quasi-coaxial line including: a center conductor that is inserted into the waveguide to contact with the cavity matching unit and is formed integrally with a probe conductor applying the signal to the waveguide; a feed a feed line connected with the center conductor; and a plurality of second metal via holes that are formed on one or more dielectric layers stacked downward from a lowermost dielectric layer among the plurality of dielectric layers of the waveguide and are spaced from the center conductor by a predetermined gap to surround the center conductor.

Besides, the feed line is any one of a microstrip line, a coplanar waveguide (CPW) line, and a stripline.

At this time, the probe conductor is a third metal via hole formed on the plurality of dielectric layers of one or more layers to contact with or be inserted into the cavity matching unit.

Besides, in the cavity matching unit, an inner part of the cavity is filled with a metallic material.

Further, the cavity matching unit has a cylindrical shape or a polygonal shape.

In addition, the cavity matching unit is formed to decrease or increase the volume of each cavity formed at a portion of each of the plurality of dielectric layers step by step.

Moreover, the cavity matching unit is a quasi-cavity.

Besides, the quasi-cavity includes: one or more third conductive plates formed on the bottom of one or more dielectric layers among the plurality of dielectric layers; and a plurality of fourth metal via holes vertically penetrating a dielectric layer having one or more layers stacked on the one or more third conductive plates to form a vertical metallic surface by surrounding the one or more third conductive plates at a predetermined interval.

Further, the quasi-cavity is formed to decrease or increase the volume of the quasi-cavity formed at a portion of each of the plurality of dielectric layers step by step.

### BRIEF DESCRIPTION OF THE DRAWINGS

FIG. 1 is a perspective view of a wideband transmission line—waveguide transition apparatus according to a first embodiment of the present invention;

FIG. 2 is a cross-sectional view of a wideband transmission line—waveguide transition apparatus taken along the line A-A′ of FIG. 1;

FIG. 3 is a perspective view of a wideband transmission line—waveguide transition apparatus according to a second embodiment of the present invention;

FIG. 4 is a cross-sectional view of a wideband transmission line—waveguide transition apparatus taken along the line B-B′ of FIG. 3;

FIG. 5 is a perspective view of a wideband transmission line—waveguide transition apparatus according to a third embodiment of the present invention;

FIG. 6 is a cross-sectional view of a wideband transmission line—waveguide transition apparatus taken along the line C-C′ of FIG. 5;

FIG. 7A is a diagram for describing the degree of positional freedom of a cavity matching unit and FIGS. 7B and 7C are diagrams for describing various shapes of the cavity matching unit;

FIG. 8 is a perspective view of a wideband transmission line—waveguide transition apparatus according to a fourth embodiment of the present invention;

FIG. 9 is a cross-sectional view of a wideband transmission line—waveguide transition apparatus taken along the line D-D′ of FIG. 8;

FIG. 10 is a perspective view of another wideband transmission line—waveguide transition apparatus according to a fourth embodiment of the present invention;

FIG. 11 is a cross-sectional view of a wideband transmission line—waveguide transition apparatus taken along the line E-E′ of FIG. 10;

FIG. 12 is a perspective view of a wideband transmission line—waveguide transition apparatus according to a fifth embodiment of the present invention;

FIG. 13 is a plan view of a wideband transmission line—waveguide transition apparatus of FIG. 12;

FIG. 14 is a cross-sectional view of a wideband transmission line—waveguide transition apparatus taken along the line F-F′ of FIG. 12; and

FIG. 15 is a graph comparing band characteristics of a known transmission line—waveguide transition apparatus and a wideband transmission line—waveguide transition apparatus according to embodiments of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

Further, although a single and multi-layer dielectric waveguide have been used as a waveguide in the present invention, the waveguide is not limited thereto and it is possible to acquire the same effect even in a metal waveguide.

All surfaces of the single and multi-layer dielectric waveguide except for a surface (e.g., a connection surface with another device) vertical to a propagation direction of a wave should form metal interfaces such that the wave is propagated to another device.

To this end, in the single and multi-layer dielectric waveguide, a conductive plate is formed on each of the top of an uppermost dielectric layer and the bottom of a lowermost dielectric layer, and metallic via holes having an opening formed on one surface of side surface of the single and multi-layer substrate and spaced by a predetermined gap are formed such that the metal interfaces are formed on side surfaces other than the surface with the opening.

As a result, in the single and multi-layer dielectric waveguide, the opening is provided on one surface of side surfaces of a single and multi-layer dielectric substrate and the metal interfaces are formed on all surfaces other than the surface with the opening.

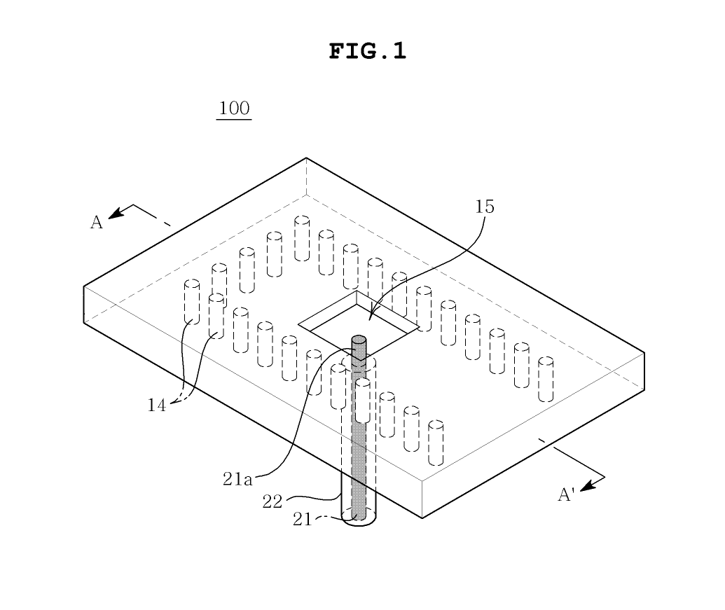

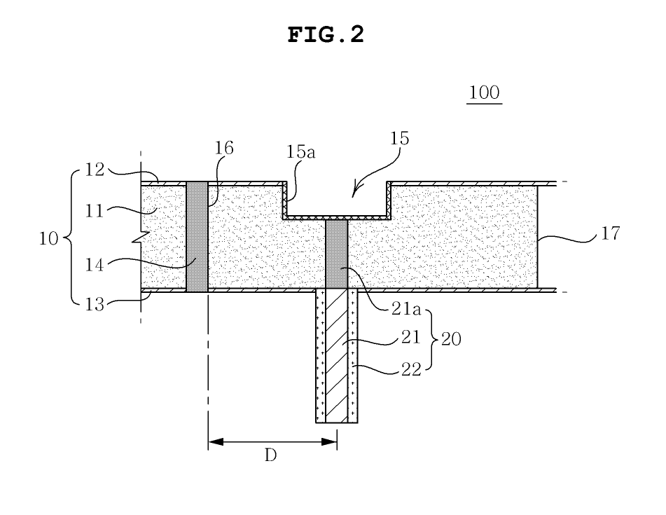

FIG. 1 is a schematic perspective view of a wideband transmission line—waveguide transition apparatus according to a first embodiment of the present invention and FIG. 2 is a cross-sectional view of a wideband transmission line—waveguide transition apparatus taken along the line A-A′ of FIG. 1.

Referring to FIGS. 1 and 2, the wideband transmission line—waveguide transition apparatus 100 according to the first embodiment of the present invention includes a waveguide 10, a transmission line 20 that is inserted into the waveguide 10 to apply a to apply a signal, and a cavity matching unit 15 for impedance matching and phase matching between the waveguide 10 and the transmission line 20.

In the first embodiment of the present invention, a single dielectric waveguide is used as the waveguide 10.

The waveguide 10 includes a dielectric substrate 11 composed of one dielectric layer, a first conductive plate 12 formed on the top of the dielectric substrate 11, a second conductive plate 13 formed on the bottom of the dielectric substrate 11, and a plurality of metallic via holes 14 having an opening 17 formed on one surface among the side surfaces of the dielectric substrate 11 and spaced by a predetermined gap to surround side surfaces of the dielectric substrate 11 such that metal interfaces are formed on side surfaces of the dielectric substrate 11 other than the surface with the opening 17.

Therefore, five surfaces (e.g., in the case of a rectangular parallelepiped waveguide of FIG. 1) other than the surface with the opening 17 are all formed by the metal interfaces, such that the waveguide 10 may operate as a waveguide.

Further, the transmission line 20 may be constituted by a coaxial line including a center conductor 21 for applying a signal and an insulator 22 surrounding the center conductor 21, but is not limited thereto.

Herein, in the center conductor 21, a conductor (hereinafter, referred to as a ‘probe conductor’) 21a inserted into the waveguide 10 may be substituted with a metallic via hole.

A TEM-mode electromagnetic wave signal is transmitted and transitioned to the waveguide 10 through the probe conductor 21a, such that a TE-mode signal is transmitted in the waveguide 10.

At this time, since the waveguide 10 and the transmission line 20 have different impedances depending on dielectric constant, signal transmission is not smooth. smooth. Therefore, in order to solve the problem, the impedance matching and phase matching between the waveguide 10 and the transmission line 20 are required.

To this end, in the present invention, the cavity matching unit 15 that performs the impedance matching and phase matching between the waveguide 10 and the transmission line 20 by forming a cavity having an inner surface formed by a metallic surface at a portion of the waveguide 10 is provided so that the cavity matching unit 15 contacts with the transmission line 20 (specifically, the probe conductor 21a of the transmission line 20).

Since the dielectric constant of the waveguide 10 may be changed by changing the size and shape of the cavity matching unit 15, the impedance matching between the waveguide 10 and the transmission line 20 is performed through adjustment of impedance and since a phase may be changed by changing a position where the cavity matching unit 15 is formed, the phase matching between the waveguide 10 and the transmission line 20 may be performed.

Specifically, the cavity matching unit 15 may perform the impedance matching by changing the dielectric constant of the waveguide 10 through a relative ratio of a volume of the cavity formed at a portion of the waveguide 10.

The cavity matching unit 15 is plated with a predetermined metallic material 15a such that the inner surface of the cavity forms the metallic surface.

Further, the cavity matching unit 15 may perform the phase matching by changing a phase of the electromagnetic wave signal depending on the position of the cavity matching unit 15, that is, a distance (hereinafter, referred to as a ‘matching short length’) D from the center of the center conductor 21 of the transmission line 20 to a matching short 16.

It is generally preferable that the matching short length D is ½λ_{g}. Herein, λ_{g} is a guided wavelength.

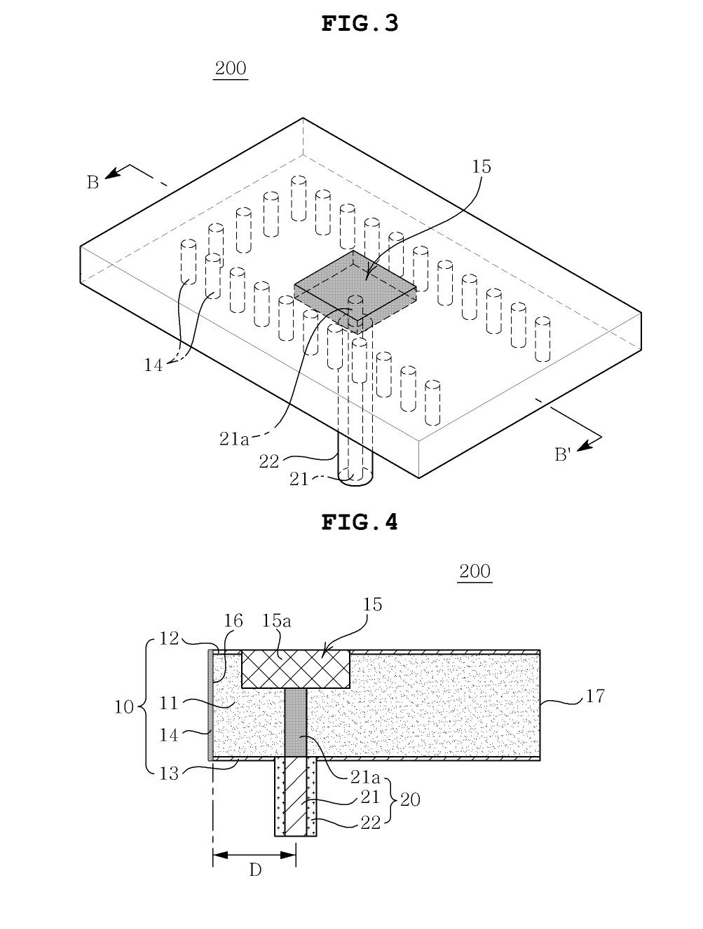

FIG. 3 is a schematic perspective view of a wideband transmission line—waveguide transition apparatus according to a second embodiment of the present invention and FIG. 4 is a cross-sectional view of a wideband transmission line—waveguide transition apparatus taken along the line B-B′ of FIG. 3.

The wideband transmission line—waveguide transition apparatus 200 according to the second embodiment of the present invention is the same as the wideband transmission line—waveguide transition apparatus 100 according to the first embodiment of the present invention shown in FIGS. 1 and 2 except for the structure of the cavity matching unit 15. Therefore, a detailed description of the same components will be substituted by the above description.

Referring to FIGS. 3 and 4, in the wideband transmission line—waveguide transition apparatus 200 according to the second embodiment of the present invention, an inner part of the cavity of the cavity matching unit 15 is filled with a predetermined metallic material 15a.

In the cavity matching unit 15 according to the second embodiment of the present invention, since the inner part of the cavity is filled with the metallic material 15a, the inner surface of the cavity may be formed by the metallic surface by the metallic material 15a and foreign materials may be prevented from being inserted into the cavity.

Accordingly, the wideband transmission line—waveguide transition apparatus 200 according to the second embodiment of the present invention may be relatively more robust than and have relatively more excellent transmission line waveguide transition characteristics than the wideband transmission line—waveguide transition apparatus 100 according to the first embodiment of the present invention.

Although the wideband transmission line—waveguide transition apparatuses 100 and 200 using the waveguide 10 formed by the single dielectric substrate have been described in FIGS. 1 to 4, the cavity matching unit 15 according to the first and second second embodiments of the present invention may be formed and applied even in a general pipe-type metallic waveguide.

Hereinafter, various embodiments of the wideband transmission line—waveguide transition apparatus using a waveguide composed of a plurality of dielectric layers will be described.

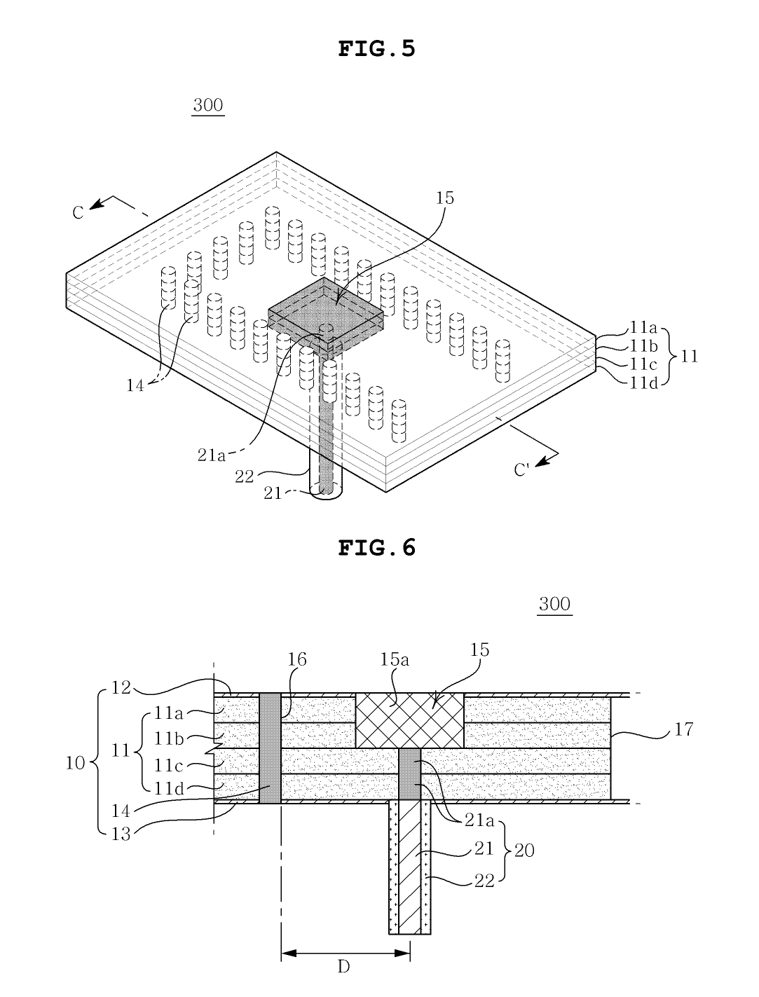

FIG. 5 is a schematic perspective view of a wideband transmission line—waveguide transition apparatus according to a third embodiment of the present invention and FIG. 6 is a cross-sectional view of a wideband transmission line—waveguide transition apparatus taken along the line C-C′ of FIG. 5.

Referring to FIGS. 5 and 6, the wideband transmission line—waveguide transition apparatus 300 according to the third embodiment of the present invention is the same as the wideband transmission line—waveguide transition apparatus 200 according to the second embodiment of the present invention shown in FIGS. 3 and 4 except for the waveguide 10. Therefore, a detailed description of the same components will be substituted by the above description.

In the third embodiment of the present invention, a multi-layer dielectric waveguide formed by stacking a plurality of dielectric layers 11a to 11d is used as the waveguide 10.

The waveguide 10 includes a dielectric substrate 11 formed by stacking the plurality of dielectric layers 11a to 11d, a first conductive plate 12 formed on the top of the dielectric substrate 11, a second conductive plate 13 formed on the bottom of the dielectric substrate 11, and a plurality of metal via holes 14 having an opening 17 formed on one surface of side surfaces of the dielectric substrate 11 and spaced by a predetermined gap to surround the side surfaces of the dielectric substrate 11 such that metal interfaces are formed on the side surfaces of the dielectric substrate 11 other than the surface with the opening 17.

In such a structure, the cavity of which the inner surface formed by the metallic surface is formed at a part of the dielectric layer (e.g., 11a and 11b) composed of one or more layers among the plurality of dielectric layers 11a to 11d and, as a result, the cavity matching unit 15 is incorporated in the waveguide 10 constituted by the plurality of dielectric layers 11a to 11d.

In the cavity matching unit 15, the inner surface is plated with the metallic material 15a or the inner part of the cavity is filled with the metallic material 15a in order to form the metallic surface on the inner surface of the cavity in the same manner as the wideband transmission line—waveguide transition apparatuses 100 and 200 of FIGS. 1 to 4.

Further, the probe conductor 21 a inserted into the waveguide 10 composed of the plurality of dielectric layers 11a to 11d in the center conductor 21 of the transmission line 20 is formed on the dielectric layer (e.g., 11c and 11d) composed of one or more layers among the plurality of dielectric layers 11a to 11d as the metal via hole so as to contact with the cavity matching unit 15.

Herein, the cavity matching unit 15 may have the high degree of positional freedom and various shapes.

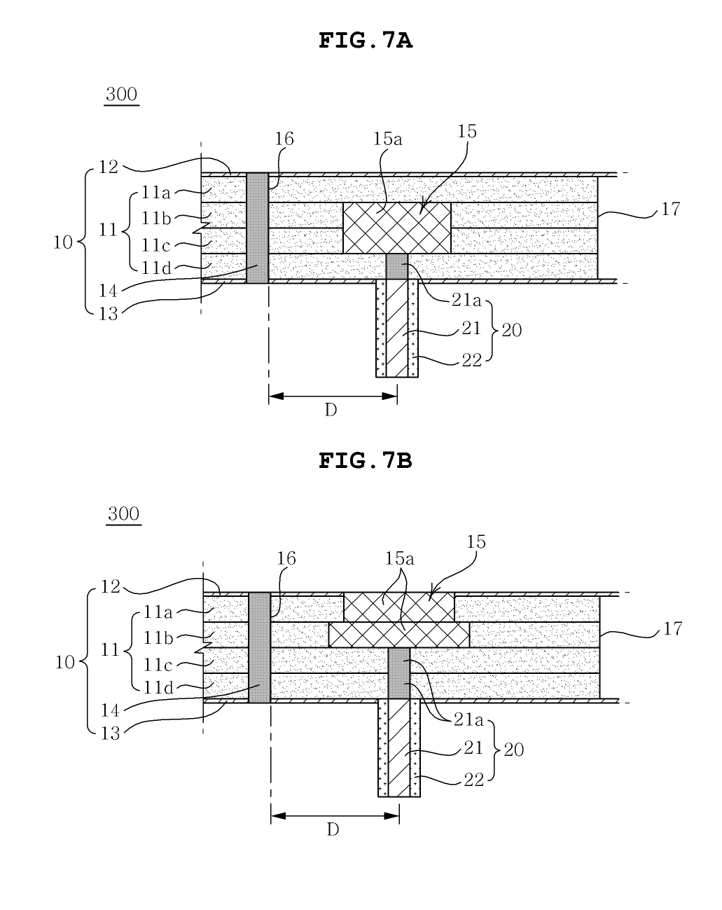

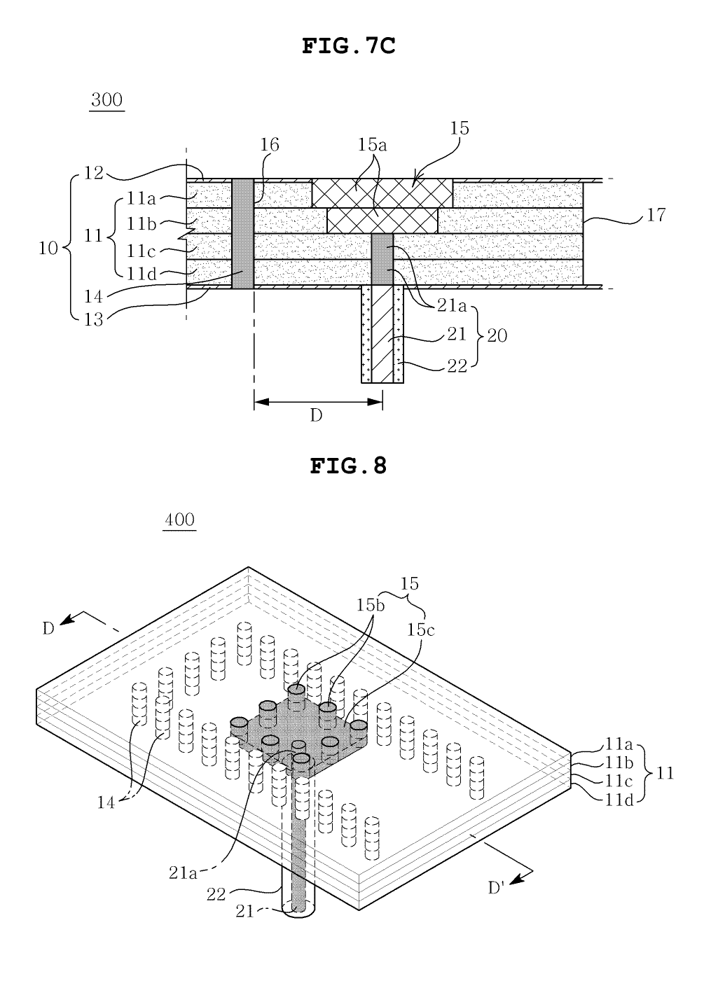

FIG. 7A is a diagram for describing the degree of positional freedom of a cavity matching unit and FIGS. 7B and 7C are diagrams for describing various shapes of the cavity matching unit.

For example, the cavity matching unit 15 may be inserted into the plurality of dielectric layers 11a to 11d as shown in FIG. 7A. As such, since the cavity matching unit 15 may be formed on any layer of the multi-layer dielectric layers 11a to 11d, the cavity matching unit 15 has the high degree of positional freedom.

Further, as shown in FIGS. 7B and 7C, the cavity matching unit 15 may be formed to decrease or increase the volume of the cavity matching unit 15 formed on each of some each of some layers (e.g., 11a and 11b) among the multi-layer dielectric layers 11a to 11d step by step.

The stepwise cavity matching unit 15 may acquire more excellent transmission line—waveguide transition characteristics by changing the relative dielectric constant between the waveguide 10 constituted by the plurality of dielectric layers 11a to 11d and the transmission line 20 step by step.

Further, the cavity matching unit 15 may have a cylindrical shape and a polygonal shape as well as a hexahedral shape as shown in FIGS. 1 to 7.

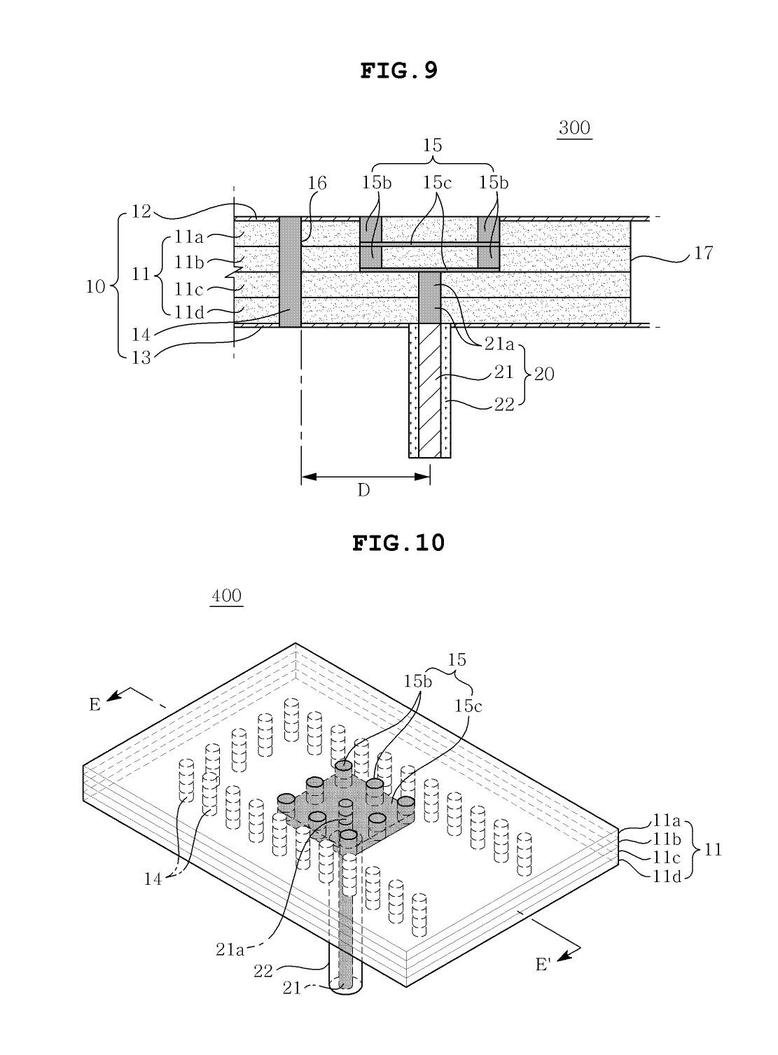

FIG. 8 is a schematic perspective view of a wideband transmission line—waveguide transition apparatus according to a fourth embodiment of the present invention and FIG. 9 is a cross-sectional view of a wideband transmission line—waveguide transition apparatus taken along the line D-D′ of FIG. 8.

The wideband transmission line—waveguide transition apparatus 400 according to the fourth embodiment of the present invention is the same as the wideband transmission line—waveguide transition apparatus 300 according to the third embodiment of the present invention shown in FIGS. 5 and 6 except for the structure of the cavity matching unit 15. Therefore, a detailed description of the same components will be substituted by the above description.

Referring to FIGS. 8 and 9, the wideband transmission line—waveguide transition apparatus 400 according to the fourth embodiment of the present invention implements the cavity matching unit 15 by forming a quasi-cavity on one or more dielectric layers (e.g., the first and second dielectric layers 11a and 11b) among the multi-layer dielectric layers 11a to 11d.

Herein, the quasi-cavity is a cavity matching unit implemented in a structure to have the same function as an actual cavity without forming the actual cavity on the plurality of dielectric layers 11a to 11d.

The quasi-cavity includes one or more conductive plates 15c formed on the bottoms of one or more dielectric layers (e.g., 11a and 11b) among the plurality of dielectric layers 11a to 11d and a plurality of metal via holes 15b vertically penetrating one or more dielectric layers 11a and 11b stacked on the one or more conductive plates 15c to form a vertical metallic surface by surrounding the one or more conductive plates 15c at a predetermined interval.

Therefore, in the cavity matching unit 15 according to the fourth embodiment of the present invention implemented by the quasi-cavity, the bottom surface of the cavity matching unit 15 is formed of the metallic surface by the one or more conductive plates 15c and the wall surface (side surface) of the cavity matching unit 15 is formed of the metallic surface by the plurality of metal via holes 15b.

As a result, all the inner surfaces of the quasi-cavity may be formed of the metallic surfaces.

Further, the probe conductor 21a of the transmission line 20 is formed of one or more dielectric layers (e.g., 11c and 11d) stacked on the bottom of the one or more conductive plates 15c among the plurality of dielectric layers 11a to 11d as the metal via hole so as to contact with the cavity matching unit 15.

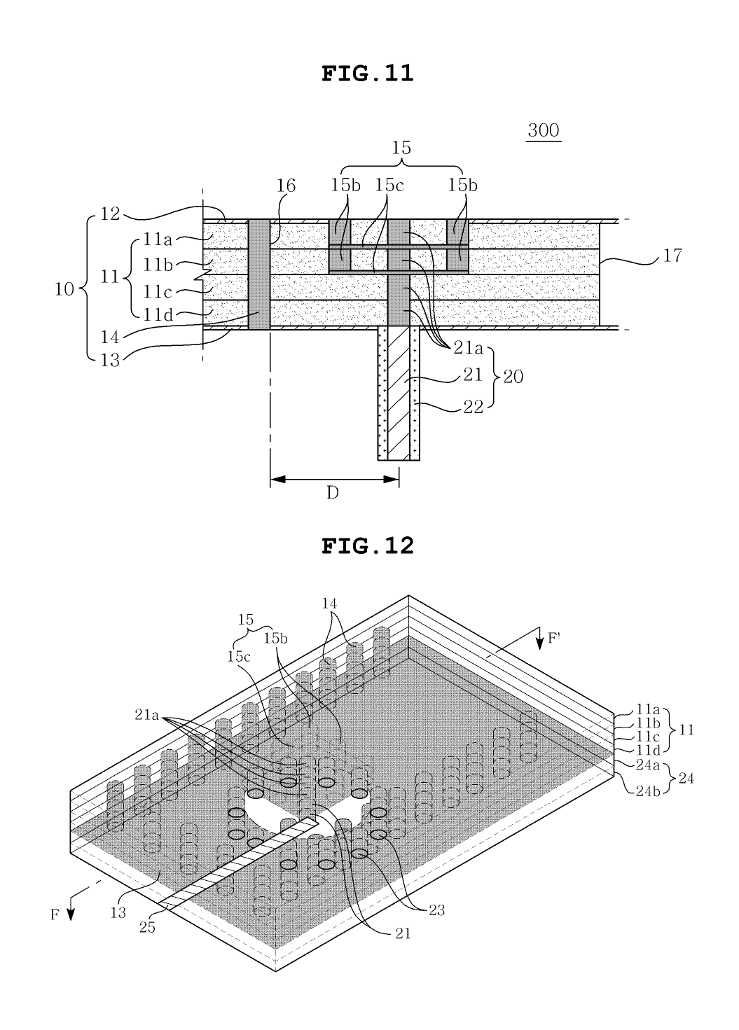

A terminal of the probe conductor 21a may form the metal via hole 21a to contact with the conductive plate 15c forming the bottom surface of the cavity matching unit 15 as shown in FIGS. 8 and 9 and may form a metal via hole 2a to be inserted into a cavity matching unit 15 as shown in FIGS. 10 and 11.

In the case of the wideband transmission line—waveguide transition apparatus 400 according to the fourth embodiment of the present invention, the cavity matching unit 15 also has the high degree of positional freedom and may be manufactured in various shapes as shown in FIGS. 7A to 7C.

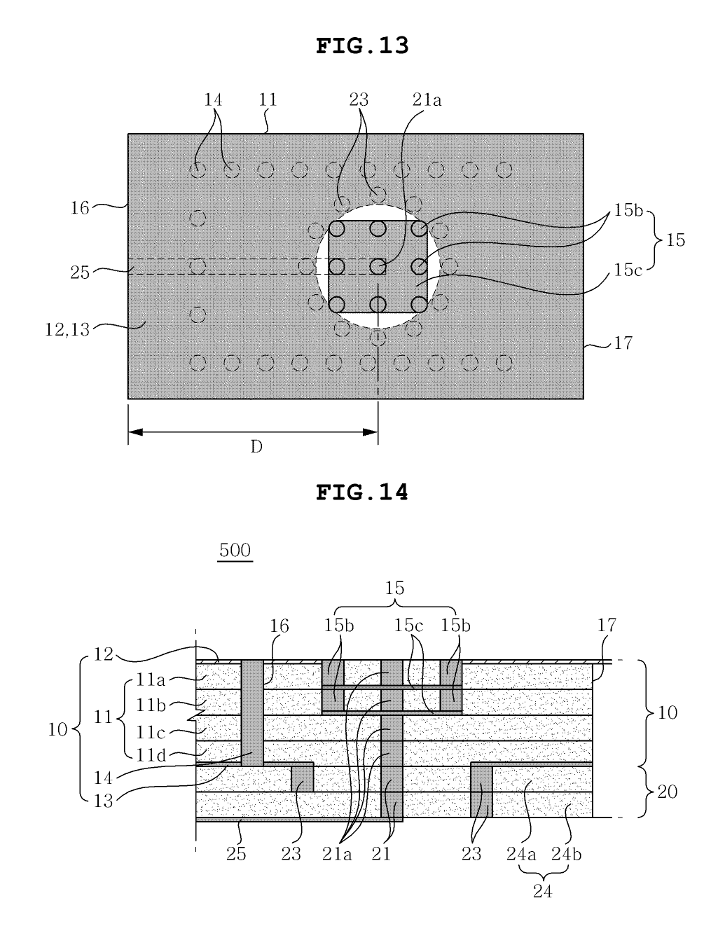

FIG. 12 is a perspective view of a wideband transmission line—waveguide transition apparatus according to a fifth embodiment of the present invention, FIG. 13 is a is a plan view of a wideband transmission line—waveguide transition apparatus of FIG. 12, and FIG. 14 is a cross-sectional view of a wideband transmission line—waveguide transition apparatus taken along the line F-F′ of FIG. 12.

The wideband transmission line—waveguide transition apparatus 500 according to the fifth embodiment of the present invention is the same as the wideband transmission line—waveguide transition apparatus 400 according to the fourth embodiment of the present invention shown in FIGS. 8 and 11 except for the structure of the transmission line 20. Therefore, a detailed description of the same components will be substituted by the above description.

Referring to FIGS. 12 to 14, the wideband transmission line—waveguide transition apparatus 500 according to the fifth embodiment of the present invention implements the transmission line 20 by using a quasi-coaxial line instead of the coaxial line.

The quasi-coaxial line performs the same function as the coaxial line described up to now and may be easily implemented on the multi-layer dielectric substrate.

At this time, the quasi-coaxial line includes the center conductor 21 that is inserted into the waveguide 10 to contact with the cavity matching unit 15 and integrally formed with the probe conductor 21a applying the signal to the waveguide 10, a feed line 25 connected with the center conductor 21, and a plurality of metal via holes 23 that are formed on one or more dielectric layers stacked downward from the lowermost dielectric layer 11d among the plurality of dielectric layers 11a to 11d of the waveguide 10 and are formed to surrounding the center conductor 21 while being spaced from the center conductor 21 by a predetermined gap.

Herein, a microstrip line, a coplanar waveguide line, and a stripline may be used as the feed line 25.

The quasi-coaxial line is apparent to those skilled in the art and will not be described in detail in the present invention.

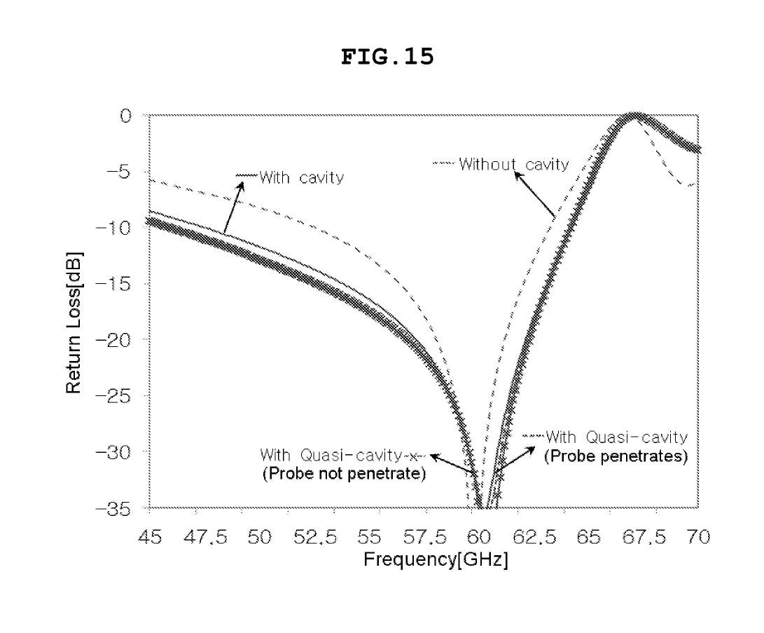

FIG. 15 is a graph comparing band characteristics of a known transmission line—waveguide transition apparatus and a wideband transmission line—waveguide transition apparatus according to embodiments of the present invention.

Referring to FIG. 15, the wideband transmission line—waveguide transition apparatuses according to the embodiments of the present invention have a frequency bandwidth larger than the known transmission line—waveguide transition apparatus without the cavity matching unit 15 on the basis of a return loss of −10 dB.

This indicates that frequency band characteristics are improved by the cavity matching unit 15 like the present invention.

As described above, the wideband transmission line—waveguide transition apparatuses 100, 200, 300, 400, and 500 according the embodiments of the present invention perform impedance matching by the cavity matching unit 15 formed in the waveguide 10 and performs phase matching by the position of the cavity matching unit 15, thereby making it possible to widen the bandwidth.

Further, the cavity matching unit 15 may be formed in the single dielectric waveguide, the pipe-type metallic waveguide, and the multi-layer dielectric waveguide and when the cavity matching unit 15 is applied to the multi-layer dielectric waveguide, the cavity matching unit 15 may be implemented by the quasi-cavity structure.

Further, in the wideband transmission line—waveguide transition apparatuses 100, 200, 300, 400, and 500 according the embodiments of the present invention, the coaxial line may be used as the transmission line 20 and when the transmission line 20 is applied to the multi-layer dielectric substrate, the transmission line 20 may be easily implemented by the quasi-coaxial line including the microstrip line (or the CPW line and the stripline).

According to the present invention, the wideband transmission line—waveguide transition apparatus can improve band characteristics through a larger bandwidth by bandwidth by performing impedance matching and phase matching between the transmission line and the waveguide by using the cavity matching unit.

Further, the wideband transmission line—waveguide transition apparatus according to the present invention can be easily implemented on both the single dielectric substrate and the multi-layer dielectric substrate, it is easy to manufacture the apparatus and the manufacturing cost thereof is saved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

1. A wideband transmission line—waveguide transition apparatus, comprising:
a waveguide constituted by a single dielectric substrate;
a transmission line applying a signal to the waveguide; and
a cavity matching unit in which a cavity of which an inner surface is formed by a metallic surface is formed at a portion of the waveguide to contact with the transmission line and impedance is adjusted through a change of the dielectric constant in the cavity caused by changing the size and shape of the cavity to perform impedance matching between the waveguide and the transmission line, and the position of the cavity is changed to perform phase matching between the waveguide and the transmission line.

2. The wideband transmission line—waveguide transition apparatus as set forth in claim 1, wherein the waveguide includes:
a single dielectric substrate constituted by one dielectric layer;
a first conductive plate formed on the top of the single dielectric substrate;
a second conductive plate formed on the bottom of the single dielectric substrate; and
a plurality of first metal via holes that have openings on one surface of side surfaces of the single dielectric substrate and are spaced to surround the side surfaces of the single dielectric substrate to form metal interfaces on the side surfaces of the single dielectric substrate.

3. The wideband transmission line—waveguide transition apparatus as set forth in claim 1, wherein the transmission line is a coaxial line including:
a center conductor that is inserted into the waveguide to contact with the cavity matching unit and is formed integrally with a probe conductor applying the signal to the waveguide; and
an insulator surrounding the center conductor.

4. The wideband transmission line—waveguide transition apparatus as set forth in claim 3, wherein the probe conductor is a second metal via hole.

5. The wideband transmission line—waveguide transition apparatus as set forth in claim 1, wherein in the cavity matching unit, an inner part of the cavity is filled with a metallic material.

6. The wideband transmission line—waveguide transition apparatus as set forth in claim 1, wherein the cavity matching unit has a cylindrical shape or a polygonal shape.

7. A wideband transmission line—waveguide transition apparatus, comprising:
a waveguide constituted by a plurality of dielectric layers;
a transmission line applying a signal to the waveguide; and
a cavity matching unit in which a cavity of which an inner surface is formed by a metallic surface is formed at a portion of one or more dielectric layers among the plurality of dielectric layers to contact with the transmission line and impedance is adjusted through a change of the dielectric constant in the cavity caused by changing the size and shape of the cavity to perform impedance matching between the waveguide and the transmission line, and the position of the cavity is changed to perform phase matching between the waveguide and the transmission line.

8. The wideband transmission line—waveguide transition apparatus as set forth in claim 7, wherein the waveguide includes:
a multi-layer dielectric substrate stacked by a plurality of dielectric layers;
a first conductive plate formed on the top of the multi-layer dielectric substrate;
a second conductive plate formed on the bottom of the multi-layer dielectric substrate; and
a plurality of first metal via holes that have openings on one surface of side surfaces of the multi-layer dielectric substrate and are spaced to surround the side surfaces of the multi-layer dielectric substrate to form metal interfaces on the side surfaces of the multi-layer dielectric substrate.

9. The wideband transmission line—waveguide transition apparatus as set forth in claim 7, wherein the transmission line is a coaxial line including:
a center conductor that is inserted into the waveguide to contact with the cavity matching unit and integrally formed with a probe conductor applying the signal to the waveguide; and
an insulator surrounding the center conductor.

10. The wideband transmission line—waveguide transition apparatus as set forth in claim 7, wherein the transmission line is a quasi-coaxial line including:
a center conductor that is inserted into the waveguide to contact with the cavity matching unit and is formed integrally with a probe conductor applying the signal to the waveguide;
a feed line connected with the center conductor; and
a plurality of second metal via holes that are formed on one or more dielectric layers stacked downward from a lowermost dielectric layer among the plurality of dielectric layers of the waveguide and are spaced from the center conductor by a predetermined gap to surround the center conductor.

11. The wideband transmission line—waveguide transition apparatus as set forth in claim 10, wherein the feed line is any one of a microstrip line, a coplanar waveguide (CPW) line, and a stripline.

12. The wideband transmission line—waveguide transition apparatus as set forth in claim 9, wherein the probe conductor is a third metal via hole formed on the plurality of dielectric layers of one or more layers to contact with or be inserted into the cavity matching unit.

13. The wideband transmission line—waveguide transition apparatus as set forth in claim 7, wherein in the cavity matching unit, an inner part of the cavity is filled with a metallic material.

14. The wideband transmission line—waveguide transition apparatus as set forth in claim 7, wherein the cavity matching unit has a cylindrical shape or a polygonal shape.

15. The wideband transmission line—waveguide transition apparatus as set forth in claim 7, wherein the cavity matching unit is formed to decrease or increase the volume of each cavity formed at a portion of each of the plurality of dielectric layers step by step.

16. The wideband transmission line—waveguide transition apparatus as set forth in claim 7, wherein the cavity matching unit is a quasi-cavity.

17. The wideband transmission line—waveguide transition apparatus as set forth in claim 16, wherein the quasi-cavity includes:
one or more third conductive plates formed on the bottom of one or more dielectric layers among the plurality of dielectric layers; and
a plurality of fourth metal via holes vertically penetrating a dielectric layer having one or more layers stacked on the one or more third conductive plates to form a vertical metallic surface by surrounding the one or more third conductive plates at a predetermined interval.

18. The wideband transmission line—waveguide transition apparatus as set forth in claim 17, wherein the quasi-cavity is formed to decrease or increase the volume of the quasi-cavity formed at a portion of each of the plurality of dielectric layers step by step.
